(19) United States
(12) Patent Application Publication
(10) Pub. No.: US 2007/0050666 A1
(43) Pub. Date: Mar. 1, 2007

(54) Computer Network System and Related Method for Monitoring a Server

(76) Inventors: Jung-Chieh Hsieh, Taipei Hsien (TW); Sen-Ta Chan, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/163,086

(22) Filed: Oct. 4, 2005

(30) Foreign Application Priority Data
Aug. 29, 2005 (TW) 094129515

(51) Int. Cl. G06F 11/00

(52) U.S. Cl. 714/6

(57) ABSTRACT

A computer network system. The computer network system includes a server with an operating system and a management system for controlling the server, and a computer connected to the operating system of the server and the management system of the server. The computer is utilized to transmit a signal to the management system of the server according to a status of the operating system of the server providing a network service.

### BACKGROUND OF THE INVENTION

1. Field of the Invention

The present invention relates to a computer network system, and more particularly, to a computer network system that does not need an agent software for network service recovery.

2. Description of the Prior Art

The robustness is very important in network. Take the core of the network system, the server, for example. If the server fails to perform some expected function, or even the server crashes, the related network services will be affected accordingly, causing users inconvenience, and even bringing loss to businesses.

To achieve continuous-time network service, or at least network service with limited break, it is necessary to monitor the status of the service of the server for instant response to any situation of the server. A solution in the prior art is installing an agent software in the server of the network system. The agent software is utilized to automatically monitor the status of the server, and to recover the function of the server when the service is interrupted.

Please refer to FIG. 1. FIG. 1 is a block diagram of a conventional computer network system 100. Via network, the server 110 of the prior art is connected to the computers 120 and 130. The computers 120 and 130 ask the server 110 for services, such as email service or web page browsing. Please refer to FIG. 2. FIG. 2 is a block diagram illustrating the conventional server 110 in FIG. 1. The conventional server 110 includes a central processing unit (CPU) 202 for executing an operating system (OS) 210, a management system 240, a network interface card (NIC) 220, and two buses 232 and 234. The operating system 210 connects to the network interface card 220 and the management system 240 through the bus 232 and the bus 234 respectively. The network interface card 220 is further connected to the network. Hence the server 110 is capable of communicating to the network. In the conventional server 110, the operating system 210 includes an agent software 212 and a driver 214 of the management system 240. Usually, the management system 240 is responsible to the power management of the server 110, including turning on/off the power of the server 110 under directions, and rebooting the server 110 for recovering the network service as well. In the prior art, the agent software 212 included in the operating system 210 of the server 110 zeros a counter 242 of the management system 240 via the driver 214 every predetermined period of time. Once the agent software 212 fails to zero the counter 242 within a predetermined time, a status of time-out occurs. That is, when a status of time-out of the counter 242 takes place, it means there is a problem in the operating system 210 of the server 110, and the network service of the server 110 might break down. At the moment, the management system 240 of the server 110 executes the task of power management in response in order to solve the problem of the server 110 and to recover the network service of the server 110.

However, the break of service of the server 110 may be caused by problems of hardware or software of the server 110. In the prior art, the management system 240 can only recover the service broken by the hardware by executing the task of power management. In the contrary, the management system 240 can do nothing about the break due to the software. Furthermore, for a multi-service server, there in no way to tell which network service is broken from the same time-out status of the counter. In addition, there may be some network service that does not cause the status of time-out when it is broken. It is obvious that the agent software cannot monitor these kinds of breaks of service. Hence the service will not be recovered in time. It can be seen that an ideal server-monitoring device should be able to tell whether the break of service is caused by failure of hardware or caused by problems of software. It is also necessary to tell which service among the provided services is broken in order to solve the problems and recover the service efficiently, or even to prevent the breaks of service in advance.

### SUMMARY OF THE INVENTION

It is therefore a primary objective of the claimed invention to provide a computer network system and related method for monitoring a server.

Briefly described, the claimed invention discloses a computer network system. The computer network system includes a server and a computer. The server includes an operating system and a management system for controlling the server. The computer is connected to the operating system of the server and the management system of the server, for transmitting a signal to the management system of the server according to a status of the operating system of the server providing a network service.

The claimed invention further discloses a method of monitoring a server. The method includes a computer transmitting a request of network service to an operating system of the server, and the computer sending a signal to a management system of the server according to a status of the server providing network service.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of the conventional computer network system.

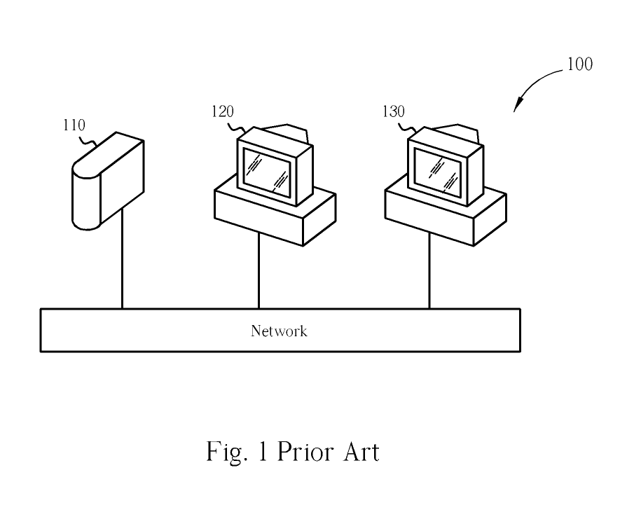

FIG. 2 is a block diagram illustrating the conventional server in FIG. 1.

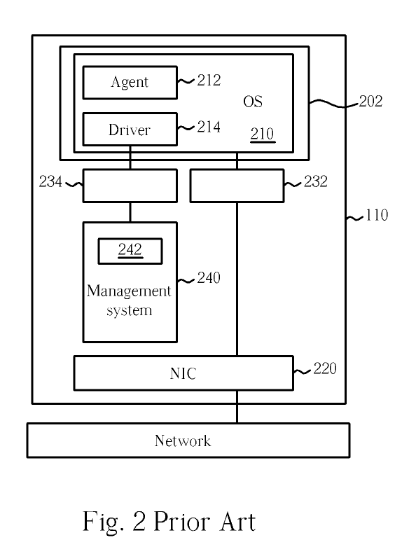

FIG. 3 is a block diagram of the present computer network system.

FIG. 4 is a flow chart of the present method for monitoring the server.

### DETAILED DESCRIPTION

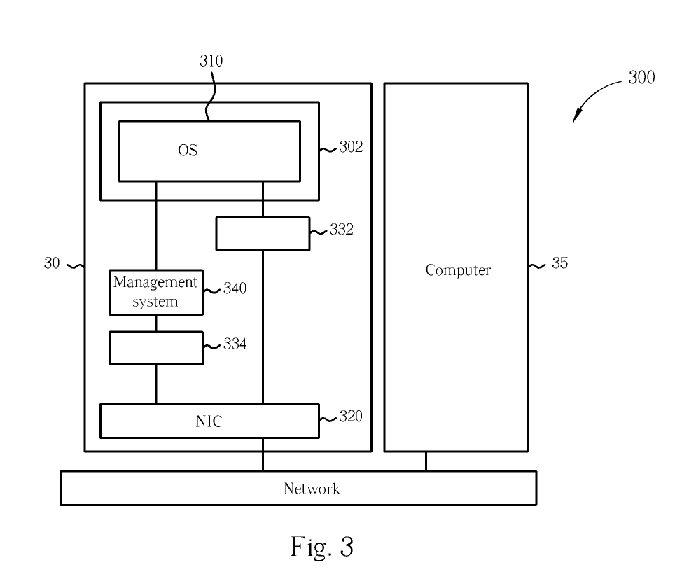

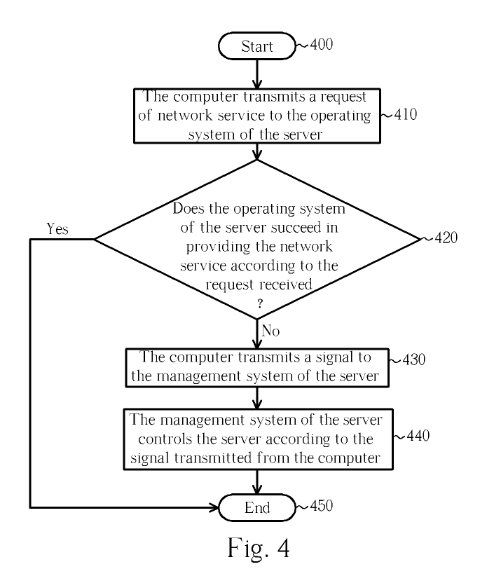

For monitoring the server providing services and for determining the causes of breaks more accurately, the present invention introduces a server needing no agent software and the related method for monitoring the server. Please refer to FIG. 3. FIG. 3 is a block diagram of the present computer network system 300. The server 30 of the present invention connects to and communicates with a computer 35 via the network. The server 30 includes a central processing unit 302 for executing an operating system (OS) 310, a management system 340, a network interface card (NIC) 320, and two buses 332 and 334. Compared to the conventional server, the operating system 310 and the management system 340 connect to the network interface card 320 via the bus 332 and the bus 334 respectively and individually. The network interface card 320 connects to the network further such that both of the operating system 310 and the management system 340 can communicate with the computer 35 via network. Please notice that the server 30 of the present invention is not equipped with an agent software within the operating system 310. The management system 340 of the present server does not control the server 30 according to signals generated from the internal agent software, but controls the server 30 directly in response to signals from the computer 35 via the network. Please refer to FIG. 4. FIG. 4 is a flow chart of the present method for monitoring the server of the claimed computer network system.

step 400: Start;

step 410: The computer transmits a request of network service to the operating system of the server;

step 420: Execute step 450 when the operating system of the server succeeds in providing the network service according to the request received; otherwise execute step 430;

step 430: The computer transmits a signal to the management system of the server;

step 440: The management system of the server controls the server according to the signal transmitted from the computer;

step 450: End.

Please refer to the computer network system of the present invention illustrated in FIG. 3 together with the flow chart of the present method in FIG. 4. In step 410, the computer 35 sends a requirement to the operating system 310 of the server 30 via the network through the network interface card 320 and the bus 332. When the operating system 310 functions correctly, the operating system 310 provides network service according to the commands from the computer 35. However, when some part of the operating system 310 breaks, the operating system 310 may not be able to provide the network service required by the computer 35 correctly, or may even make no response. According to the present invention, in step 430, the computer 35 transmits a signal to the management system 340 of the server 30 according to how the server 30 provides network service in response to the requirement of the computer 35. Please notice that in the claimed server 30, the management system 340 also connects to the network interface card 320 of the server 30 through the bus 334. Hence the computer 35 is able to transmit a signal to the management system 340 of the server 30 directly. Practically, the network interface card 320 of the server 30 may include a plurality of ports so that the bus 332 and the bus 334 can connect to the network interface card 320 separately. That is, the operating system 310 and the management system 340 are connected to the same network interface card 320. Or the server 30 may include a plurality of network interface cards, such that the operating system 310 and the management system 340 can connect to the computer network through different network interface cards. When the management system 340 of the server 30 receives the signal transmitted from the computer 35 via the computer network and through the network interface card 320 and the bus 334, the management system 340 of the present invention can control the server 30 to recover the network services in response to the signal from the computer 35.

In the present invention, the computer 35 transmits different signals to the management system 340 according to the required network service and the response of the server 30. Therefore, the management system of the present invention receives information more completely, and catches the situation of the server providing services with more details. For example, the computer 35 of the present invention can be designed to send out different signals when the computer 35 asks the server 30 for email service but the server 30 fails to provide and when the computer 35 asks the server 30 for web page exploring but the server 30 fails to provide. Hence the management system 340 of the present invention can catch the information about how the server 30 fails to provide network service, and can execute related tasks of recovery accordingly. With no doubts, the management system of the present server is able to perform power management, including turning on/off the power of the server and rebooting the server, as the conventional management system is.

In summary, the server of the present invention gives up the conventional scenario of reacting to the status of the operating system by the counter. Hence the claimed server does not need to be equipped with any agent software in the operating system, but the management system of the claimed server is connected to the network directly for receiving signals about how the server providing services from an external computer. The management system of the present invention can determine the problems of the server when the server fails to provide service correctly, and can recover the function of the server successfully. As illustrated in FIG. 3, the external computer 35 may be a device dedicated to monitoring how the server provides services. The dedicated computer 35 can be designed to require for different network services by turns for testing each network service expected to be provided by the server. The computer 35 in FIG. 3 can also be a common computer using network services. That is, the present invention includes that whenever a user requires a network service but fails to have the network service, the computer of the user automatically transmits a signal to the management system of the server for reporting the break of the service. In the present invention, the requirement of the network service of the external computer can be seen as a requirement of a common user to the server. Hence there is no extra burden to the design of the software and hardware of the server. Further, this external computer can be utilized to monitor more than one server. Hence a computer network system with low cost and high efficiency is achieved by the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computer network system comprising:
a server comprising:
an operating system; and
a management system for controlling the server; and
a computer, connected to the operating system of the server and the management system of the server, for transmitting a signal to the management system of the server according to a status of the operating system of the server providing a network service.

2. The computer network system of claim 1 wherein the computer is further for requesting a network service from the operating system of the server.

3. The computer network system of claim 1 wherein the computer is for transmitting a signal to the management system of the server when the operating system of the server fails to provide the network service.

4. The computer network system of claim 1 wherein the management system of the server is for controlling the server according to the signal transmitted from the computer.

5. The computer network system of claim 4 wherein the management system of the server is capable of controlling the server to reboot according to the signal transmitted from the computer.

6. The computer network system of claim 4 wherein the management system of the server is capable of turning off the power of the server according to the signal transmitted from the computer.

7. The computer network system of claim 4 wherein the management system of the server is capable of turning off the power of the server and then turning on the power of the server according to the signal transmitted from the computer.

8. The computer network system of claim 1 wherein the server further comprises:
a central processing unit for executing the operating system; and
a first bus connected to the central processing unit;
wherein the computer is connected to the operating system via the first bus.

9. The computer network system of claim 8 wherein the server further comprises a network interface card connected to the first bus, wherein the computer is connected to the first bus via the network interface card.

10. The computer network system of claim 1 wherein the server further comprises a second bus connected to the management system of the server, wherein the computer is connected to the management system via the second bus.

11. The computer network system of claim 10 wherein the server further comprises a network interface card connected to the second bus, wherein the computer is connected to the second bus via the network interface card.

12. The computer network system of claim 1 wherein the computer is for requesting the operating system of the server a network service every predetermined period of time.

13. The computer network system of claim 1 wherein the computer is for requesting the operating system of the server a network service when the computer receives a command.

14. A method of monitoring a server, the method comprising:
(a) a computer transmitting a request of network service to an operating system of the server; and
(b) the computer sending a signal to a management system of the server according to a status of the server providing network service.

15. The method of claim 14 wherein in step (b) the computer sending a signal to a management system of the server when the server fails to provide network service in response to the request from the computer in step (a).

16. The method of claim 14 further comprising:
(c) the management system of the server controlling the server according to the signal sent from the computer in step (b).

17. The method of claim 16 wherein in step (c) the management system of the server controlling the server to reboot according to the signal sent from the computer in step (b).

18. The method of claim 16 wherein in step (c) the management system of the server turning off the power of the server according to the signal sent from the computer in step (b).

19. The method of claim 16 wherein in step (c) the management system of the server controlling the server to turn off the power then turn on the power according to the signal sent from the computer in step (b).

20. A server comprising:
an operating system capable of connecting to a computer network; and
a management system capable of connecting to the computer network and controlling the server.

21. The server of claim 20 wherein the operating system is further capable of providing a network service via the computer network.

22. The server of claim 20 wherein the management system is capable of controlling the server according to a signal received via the computer network.

23. The server of claim 22 wherein the management system is capable of controlling the server to reboot according to the signal received via the computer network.

24. The server of claim 22 wherein the management system is capable of turning off the power of the server according to the signal received via the computer network.

25. The server of claim 22 wherein the management system is capable of controlling the server to turn off the power and then to turn on the power according to the signal received via the computer network.

26. The server of claim 22 wherein the management system is capable of controlling the server according to the signal received from a computer via the computer network.

27. The server of claim 20 further comprising:
a central processing unit for executing the operating system; and
a first bus connected to the central processing unit;
wherein the operating system is connected to the computer network via the first bus.

28. The server of claim 27 further comprising a network interface card connected to the first bus, wherein the operating system is connected to the computer network via the first bus and the network interface card.

29. The server of claim 20 further comprising a second bus connected to the operating system, wherein the operating system is connected to the computer network via the second bus.

30. The server of claim 29 further comprising a network interface card connected to the second bus, wherein the operating system is connected to the computer network via the second bus and the network interface card.
